(19) United States
(12) Patent Application Publication
(10) Pub. No.: US 2004/0042621 A1
(43) Pub. Date: Mar. 4, 2004

(54) Multichannel television sound (MTS) stereo television encoder

(75) Inventor: Phillip J. Hausman, Cary, NC (US)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: Peracom Networks, Inc., Morrisville, NC

(21) Appl. No.: 10/232,553

(22) Filed: Aug. 29, 2002

(51) Int. Cl. H04H 5/00

(52) U.S. Cl. 381/2

(57) ABSTRACT

A system and method serves to generate a composite audio signal capable of modulating a radio frequency carrier to a standard television channel for cable transmission. The system includes inputs for a first audio signal, a second audio signal, and a video signal. A third audio signal is generated which is the sum of the audio signals. A fourth audio signal is generated from the difference of the audio signals. The fourth audio signal is pre-emphasized twice and a timing signal is extracted. A first frequency pilot signal is generated from the timing signal. A second frequency subcarrier signal is also generated from the timing signal. The pre-emphasized fourth audio signal is compressed and modulated. The composite audio signal is generated from the third audio signal, the compressed and modulated fourth audio signal, and the pilot signal.

### BACKGROUND OF THE INVENTION

1. Field of the Invention

The present invention relates in general to signal processing of television signals. More specifically, the present invention relates to processing stereo audio and line level video signals in accordance with the Multichannel Television Sound (MTS) television broadcast standard, officially known as the Broadcast Systems Television Committee (BTSC) standard, to generate a composite audio signal capable of modulating a radio frequency (RF) carrier, at a specific television channel, for cable transmission.

2. Description of the Related Art

A problem with currently available MTS stereo signal processing systems is they are more complex and more expensive than necessary to generate acceptable stereo audio signals for the average home cable television user. Because currently available MTS stereo signal processing systems were designed to satisfy the less tolerant free space transmission environment, as opposed to the more tolerant cable transmission environment, they are comprised of more components and occupy more circuit board space than necessary for adequate cable transmission. Additionally, currently available systems are problematic because they implement multiple filtering stages, which truncate the audio frequency response at about twelve or thirteen kilohertz, short of the full audio range of fifteen kilohertz and also cause unwanted phase aberrations.

An MTS stereo signal processing system for cable transmission is needed that is designed to meet the needs of the average home cable television user and that takes advantage of the more tolerant cable transmission environment. A system is needed that uses fewer components and costs less than currently available MTS stereo signal processing systems. Furthermore, a system is needed that utilizes the full fifteen kilohertz audio range and that avoids unwanted phase aberrations.

### SUMMARY OF THE INVENTION

The present invention is more suitable to the less exacting requirements of the average home cable television user. Because the present invention is designed to take advantage of the more tolerant cable transmission environment, it is implemented with fewer components, therefore, the present invention is less complex, less expensive, and occupies less physical circuit board space than currently available systems. Through unique treatment and implementation of the pre-emphasis characteristics of the system's noise reduction circuit, the present invention generates a composite audio signal with a unique audio frequency response that occupies the entire fifteen-kilohertz audio range. Additionally, because the present invention avoids multiple filtering stages, the present invention is less complex, does not truncate the audio frequency response, and avoids unwanted phase aberrations. The present invention is also cost-efficient because unlike currently available systems, the system is powered by a single, low-voltage power supply.

In one aspect, a system for generating a composite audio signal capable of modulating a radio frequency carrier to a standard television channel for cable transmission is disclosed. The system includes an input for a first audio signal, for a second audio signal and for a video signal. A first generating circuit is provided for generating a third audio signal which is the sum of the first and second audio signals input into the system. A second generating circuit serves to generate a fourth audio signal which is the different between the first and second audio signals input into the system. A first pre-emphasizing circuit serves to pre-emphasize the fourth audio signal a first time and a second pre-emphasizing circuit serves to pre-emphasize the fourth audio signal a second time.

An extracting circuit functions to extract a timing signal of a first frequency from the video signal. A pilot signal circuit serves to generate from the timing a signal a pilot signal of the first frequency and a sub-carrier signal of a second frequency. A compressing circuit is for compressing the twice pre-emphasized fourth audio signal. A suppressing circuit serves to suppress the sub-carrier signal and for modulating the compressed fourth audio signal. A composite signal circuit serves to generate the composite audio signal from the third audio signal, the compressed and modulated fourth audio signal, and the pilot signal.

In a different aspect, a method of generating a composite audio signal capable of modulating a radio frequency transmitter to a standard television channel for cable television is provided. A first audio signal, a second audio signal and a video signal are initially received. The first and second audio signals are summed to generate a third audio signal. The difference between the first and second audio signals is obtained to generate a fourth audio signal. The fourth audio signal is pre-emphasized a first time, and thereafter pre-emphasized a second time. A timing signal of a first frequency is extracted from the video signal. A pilot signal of the first frequency and a subcarrier signal of a second frequency are generated from the timing signal. The twice pre-emphasized fourth audio signal is compressed. The subcarrier signal is suppressed and the compressed fourth audio signal is modulated. The third audio signal, the compressed and modulated fourth audio signal, and the pilot signal are summed to generate the composite audio signal.

### BRIEF DESCRIPTION OF THE DRAWINGS

The following brief description of the drawings will provide a better understanding of the present invention when viewed in context of the detailed description of the invention.

FIG. 1 is a block diagram of an MTS TV stereo encoder system according to an embodiment of the present invention.

FIG. 2 is a block diagram of a stereo matrix generator circuit of the MTS TV stereo encoder of FIG. 1.

FIG. 3 is a block diagram of a sync separator circuit of the MTS TV stereo encoder of FIG. 1.

FIG. 4 is a block diagram of an implementation of the Pilot & Sub-Carrier Generator circuit of the MTS TV Stereo Encoder of FIG. 1.

FIG. 5 is a block diagram of an implementation of the Compressor & Balanced Modulator circuit of the MTS TV Stereo Encoder of FIG. 1.

FIG. 6 is a block diagram of an implementation of the Summing & Output Amplifiers circuit of the MTS TV Stereo Encoder of FIG. 1.

FIG. 7 is a plot of the signature audio frequency response of an implementation of the MTS TV Stereo Encoder.

FIG. 8 is a schematic diagram illustrating an embodiment of the Stereo Matrix Generator circuit of the MTS TV Stereo Encoder.

FIG. 9 is a schematic diagram illustrating an embodiment of the Sync Separator circuit of the MTS TV Stereo Encoder.

FIG. 10 is a schematic diagram illustrating an embodiment of the Pilot & Sub-Carrier Generator circuit of the MTS TV Stereo Encoder.

FIG. 11 is a schematic diagram illustrating an embodiment of the Compressor & Balanced Modulator circuit of the MTS TV Stereo Encoder.

FIG. 12 is a schematic diagram illustrating an embodiment of the Summing & Output Amplifiers circuit of the MTS TV Stereo Encoder.

FIG. 13 is a schematic diagram illustrating an embodiment of an RF modulator capable of transmitting the composite stereo audio output signal of the MTS TV Stereo Encoder.

### DETAILED DESCRIPTION OF THE PREFERRED EMBODIMENTS OF THE PRESENT INVENTION

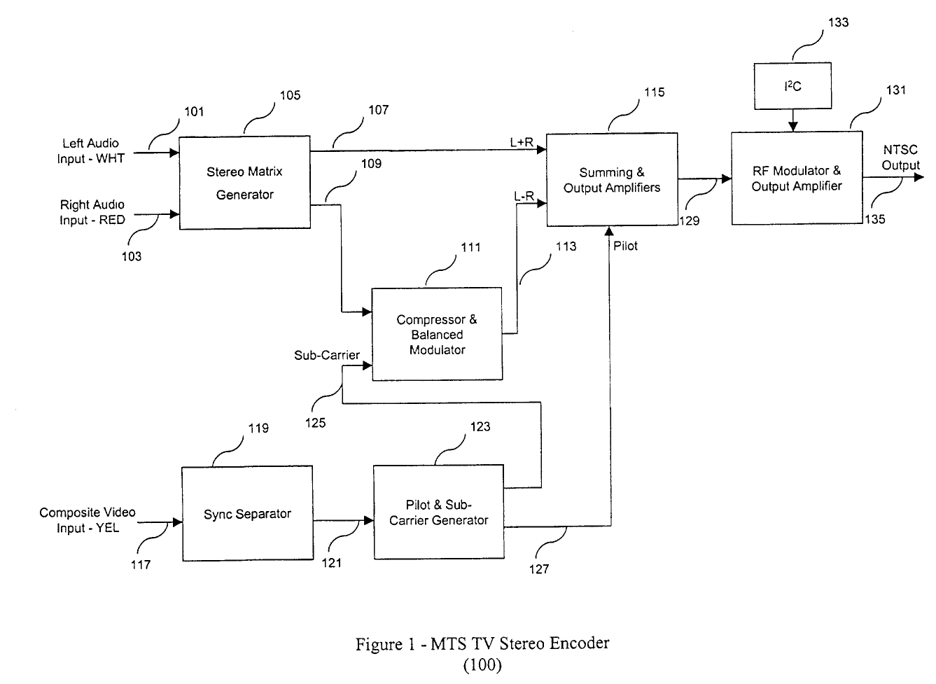

As shown in FIG. 1, an embodiment of the present invention includes an analog system 100 that accepts line level video 117, left audio 101, and right audio 103 input signals and processes these signals in accordance with the Broadcast Television Systems Committee (BTSC) television broadcast standards, often referred to as Multichannel Television Sound (MTS) standards, to produce a composite stereo audio output signal 129 capable of modulating a radio frequency (RF) transmitter set 131 to a standard television channel.

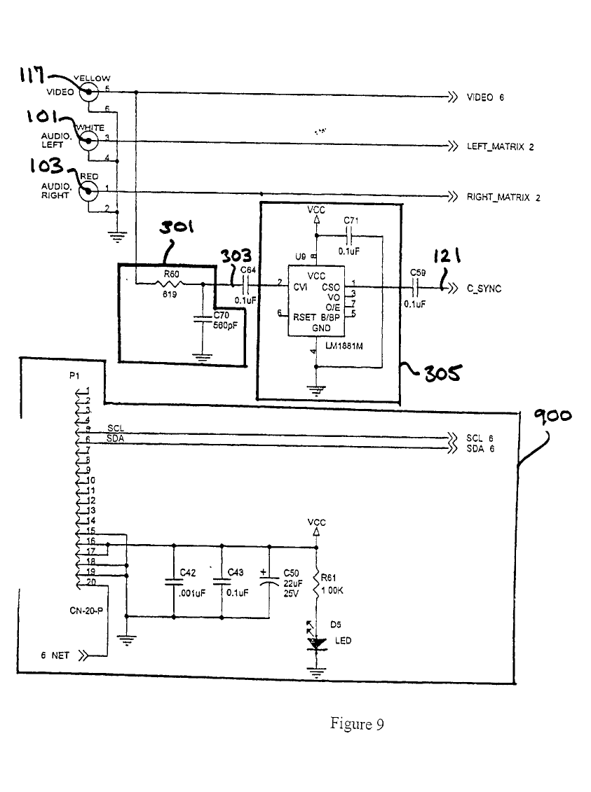

Referring to FIG. 9, the left 101 and right 103 audio input signals are accepted through the WHITE and RED RCA female jacks of assembly J1, respectively. The left 101 and right 103 audio input signals are line level signals, defined as 1.0 Volt peak-to-peak (Vₚ₋ₚ) at 500 ohms to 10,000 ohms impedance. The input voltage level should not exceed 3.0 Vₚ₋ₚ because higher levels will cause distortion.

The system 100 of FIG. 1 operates from a single, external, low-voltage power source 900. As shown in FIG. 9, the power source is +5.000 Volts DC (+/−10%, 20 mV maximum ripple) at 0.100 Amps. The power source 900 is applied to P1 (pin 16/17) and is filtered through capacitors C42, C43, and C50. A visual indicator shows when power is applied (R61/D5). The ground return path is provided on P1 (pins 15/18/19).

As shown in FIG. 1, the left 101 and right 103 audio input signals are coupled to a Stereo Matrix Generator circuit 105 that generates two separate audio channels 107 and 109. The first channel 107 is the algebraic sum of the left 101 and right 103 audio input signals and is also the monophonic channel for non-stereo receivers. The second channel 109 is the algebraic difference between the left 101 and right 103 audio input signals.

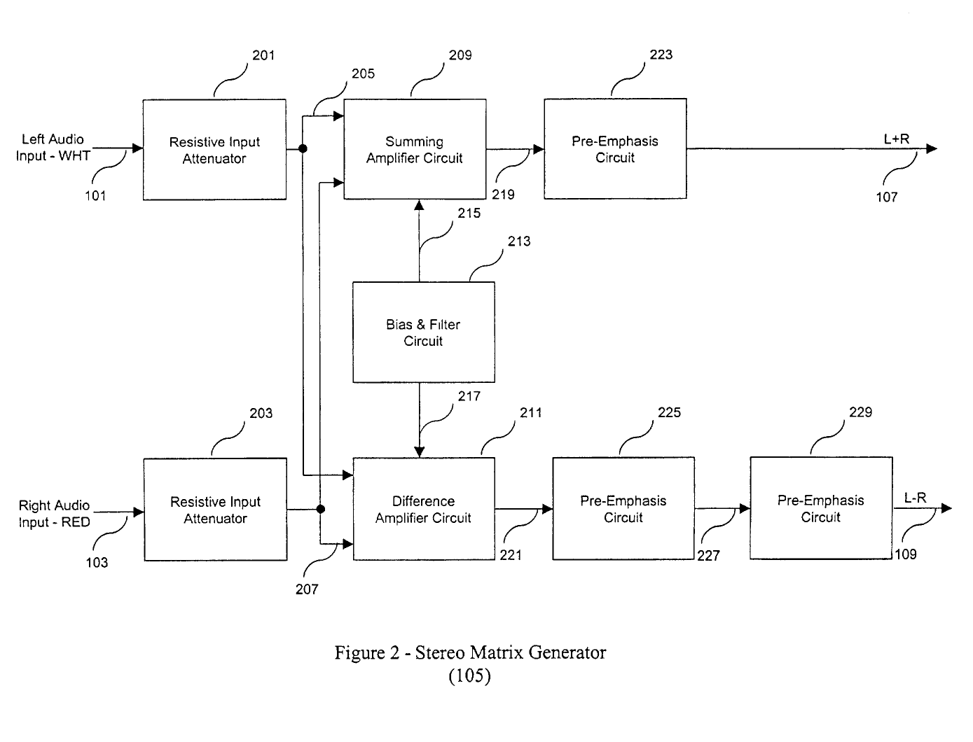

As shown in FIG. 2, the left 101 and right 103 audio input signals are passed through resistive input attenuator circuits 201 and 203, respectively. The attenuated left 205 and right 207 audio input signals are fed to the inputs of a summing amplifier circuit 209 and a difference amplifier circuit 211, which together comprise the Stereo Matrix Generator 105. Because the system 100 is powered by a single power supply 900, a bias and filter circuit 213 conditions the power supplied to the amplifiers 209 and 211.

The output of the summing amplifier circuit 219, the L+R summed audio signal, is fed to a pre-emphasis circuit 223 that pre-emphasizes or provides gain to increase the higher frequency signal levels in order to maintain a superior signal-to-noise ratio. The output of the difference amplifier circuit 221, the L−R difference audio signal, is fed to a first pre-emphasis circuit 225, the output of which 227 is then fed to a second pre-emphasis circuit 229. The purpose of the additional pre-emphasis circuit is to again pre-emphasize or decrease the low frequency effects on the Compressor & Balanced Modulator 111. In considering this it is noted that the phase shifts at low frequencies (50 Hz to 300 Hz) must be minimized in order to maintain proper stereo separation. The output of the pre-emphasis circuit 223 is the L+R main audio channel 107 and the output of the pre-emphasis circuit 229 is the L−R audio sub-channel 109.

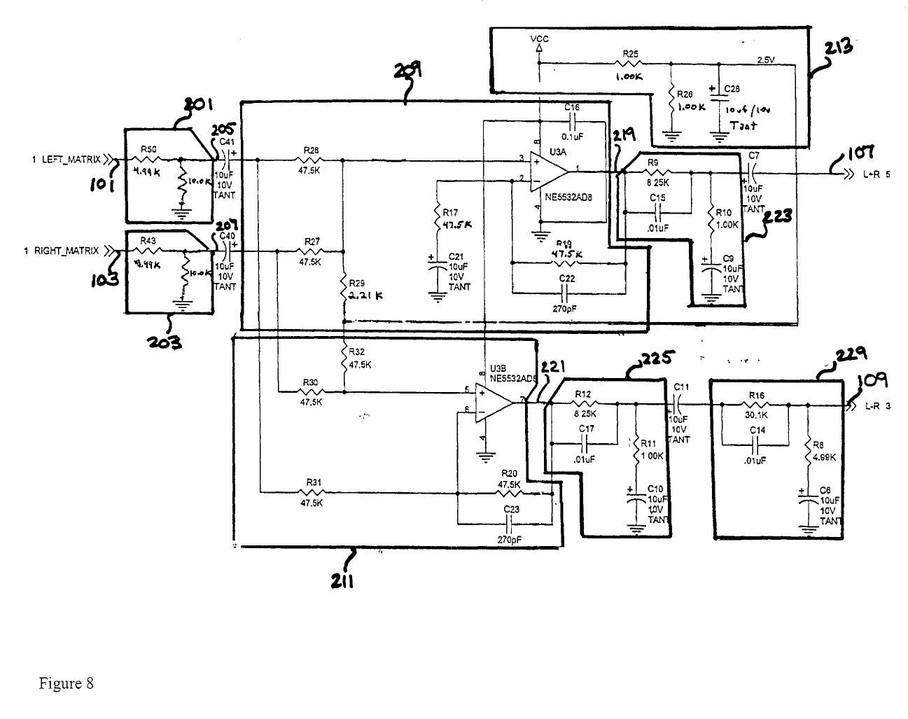

Referring to FIG. 8, the system 100 of FIG. 1 includes resistive input attenuators 201 and 203 designed to provide a flat (+/−0.75 dB) fixed attenuation level of 3.0 dB across the 50 Hz to 15,000 Hz input frequency range (R50/10 kΩ & R43/10 kΩ). The output signals of the resistive attenuators 201 and 203 are AC coupled (C41 & C40) to the inputs of the summing amplifier (U3A) and the difference amplifier (U3B).

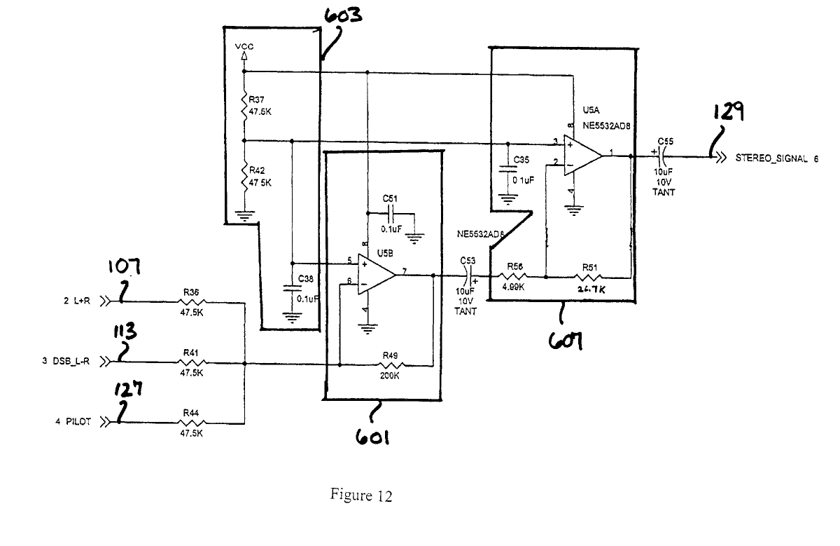

The L+R main audio channel 107 is generated by summing the output signals of the attenuators 201 and 203 using two equal value resistors (R28/R27). The summed signal is fed to the non-inverting input of an operational amplifier (U3A). The +5.0 Volts DC power source (+V_{cc}) that powers U3A is biased and filtered to 1/2+V_{cc} via a bias and filter circuit 213 (R25/R26/C26/R29). Additionally, an AC attenuator (R29 & C26) provides an attenuation factor of about 21. A feedback circuit (Ri9/C22 & R17/C21) provides a gain of about 2. A high frequency limiting capacitor (C22) prevents oscillation and unacceptable gain phase margin errors. Another capacitor (C21) prevents DC coupling, while providing an AC ground return path. The L+R summed audio signal 219 is fed to the 72.93 μs pre-emphasis network 223 (R9/C15/R10/C9). The 72.93 μs pre-emphasis network 223 provides the recommended amplitude from −2.0 dB to +17.0 dB over the audio spectrum of 50 Hz to 15000 Hz. The signal from the pre-emphasis network 223 is fed to an AC attenuator (R10/C9) within the pre-emphasis network 223 that attenuates the signal by a factor of about 3.3 and provides the proper input balance to the summing amplifier stage (U5B) shown in FIG. 12. The L+R main audio channel 107 is AC-coupled (C7) to the summing amplifier stage (U5B) shown in FIG. 12 (described further herein).

The L−R audio sub-channel 109 is generated by feeding (via R30) the attenuated right audio input signal 207 to the non-inverting input of the difference amplifier (U3B) of the difference amplifier circuit 211 and by feeding (via R31) the attenuated left audio input signal 205 to the inverting input of the difference amplifier (U3B) of the difference amplifier circuit 211. Further to the difference amplifier circuit 211, a feedback resistor (R20) in parallel with a high frequency limiting capacitor (C23) produces a gain of about 1. A resistor (R32) provides a DC path for biasing the amplifier (U3B) (via C26/26/R25) (FIG. 8), while providing an AC ground return path for the audio signal. The L−R difference audio signal 221 is fed to the 72.93 μs pre-emphasis network 225 (R12/C17/R11/C10). The output of the 72.93 μs pre-emphasis network is AC coupled (C11) to a 300 μs pre-emphasis network 229 (R16/C14/R8/C6). The output of the 300 μs pre-emphasis network 229 is the L-R audio sub-channel 109.

Further to FIG. 1, the composite video input signal 117, a National Television Systems Committee (NTSC) standard negative going signal, is fed to a Sync Separator 119 that extracts a timing signal 121 from the composite video input signal 117. The internal circuits of the system 100 are synchronized to the extracted timing signal 121.

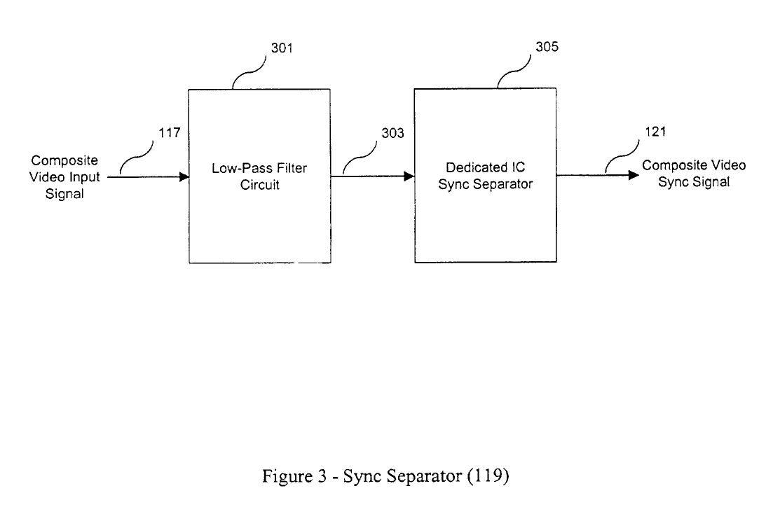

As shown in FIG. 3, the Sync Separator 119 is comprised of a low-pass filter circuit 301, which passes a filtered composite video input signal 303 to a dedicated integrated circuit (IC) sync separator 305.

Referring to FIG. 9, the composite video input signal 117 shown in FIG. 3 is obtained from the YELLOW female RCA input jack (J1). The composite video signal 117 is passed through a low-pass chroma filter 301 (R60/C70) with a corner frequency (−3.0 dB) of about 500 KHz which causes a decrease in video sub-carrier content of about 18 dB and results in a composite sync delay of 40 ns to 200 ns. The filtered composite video input signal 303 shown in FIG. 3 is AC coupled to a commercially available sync separator IC 305 (U9). The output of the sync separator IC 305 is the composite video sync signal 121, which operates at a frequency of 15.734 KHz (63 μs period—line interval) and is AC coupled (C59) to the Pilot & Sub-Carrier Generator 123 shown in FIG. 1. A capacitor (C71) decouples the +5.0 Volts DC power supply (+V_{cc}).

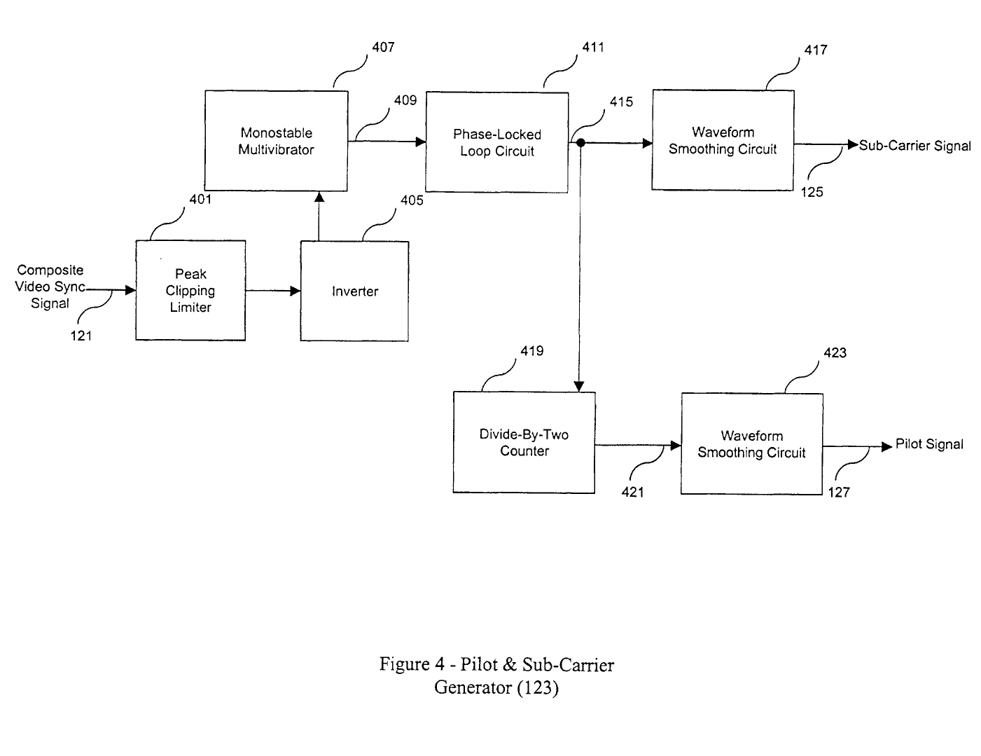

Further to FIG. 1, the Pilot & Sub-Carrier Generator 123 receives the composite video sync signal 121 and outputs a pilot 127 and a sub-carrier 125 signal. As shown in FIG. 4, the Pilot & Sub-Carrier Generator 123 from FIG. 1, provides waveform shaping by passing the square wave composite video sync signal 121 through a peak clipping limiter 401 and an inverter 405. A monostable multivibrator 407 triggers on the composite video sync pulse, while ignoring the other video pulse information that is present, and generates a new square wave 409 that is in sync with the composite video sync signal 121, but that does not contain any potential artifacts. A phase-locked loop (PLL) circuit 411 receives the square wave signal of a first frequency 409 and generates a square wave signal of a second frequency 415 that is two times the first frequency. The PLL circuit 411 also synchronizes the pilot 127 and sub-carrier 125 waveforms to the composite video sync signal 121. A waveform smoothing circuit 417 generates a sub-carrier signal 125 of the second frequency from the square wave signal of the second frequency 415. A divide-by-two counter 419 generates a new square wave signal of the first frequency 421. A waveform smoothing circuit 423 generates a pilot signal 127 of the first frequency from the square wave signal of the first frequency 421.

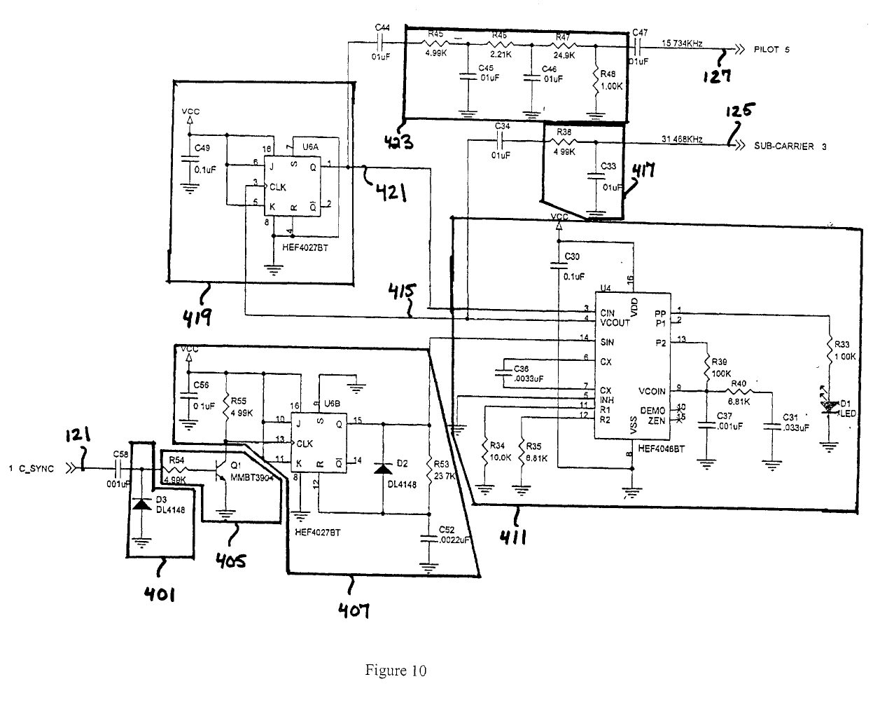

Referring to FIG. 10, the composite video sync signal 121 shown in FIG. 1 is AC coupled (C58) to a peak clipping limiter 401 (D3). The output of the peak clipping limiter 401 is fed to a transistor (Q1) configured as part of an inverter 405 that inverts the negative-going composite video sync signal 121. A resistor (R54) serves as a base drive reduction resistor for the inverter 405. A J-K flip-flop (U6B) is configured as a non-retriggerable one-shot monostable multivibrator 407 with an output oscillation frequency of 15.734 KHz (63.0 μs) being established by D2/R53/C52. The 15.735 KHz composite video sync signal is fed to the Clock Input of the monostable multivibrator 407 (U6B), J and K are tied to +V_{cc}, and Set is tied to ground. The output is a 50/50 (50%) duty cycle square wave 409 shown in FIG. 4, which is used by the PLL 411 (U4) as the signal input frequency.

A capacitor (C36) sets the PLL 411 (U4) voltage-controlled oscillator (VCO) center frequency to approximately two times the input frequency of 15.734 KHz (approximately 31.468 KHz). A resistor (R34) sets the maximum VCO pull-in frequency and a resistor (R35) sets the minimum VCO pull-in frequency. The PLL 411 (U4) has a loop filter (R39/R40/C37/C31). A capacitor (C37) makes the loop filter second order, which improves its response to transients. A resistor and a capacitor (R39&C31) determine the loop setting time and two resistors (R39&R40) determine the damping factor. Indicators (R33&D1) show when the loop is locked by maximum brightness of the LED. The PLL 411 (U4) VCO outputs a 31.468 KHz square wave signal 415 shown in FIG. 4, which is AC coupled (C34) and passed through a smoothing circuit 417 (R38/C33) that generates a 31.468 KHz triangle waveform sub-carrier signal 125.

The PLL 411 (U4) VCO 31.468 KHz square wave signal 415 is also routed to the second half of the type J-K flip-flop (U6A), which is configured as a divide-by-two counter 419. Set and Reset are connected to ground, J and K are connected to +V_{cc}, and a capacitor (C49) provides decoupling. The divided-by-two 15.734 KHz “Q—prime” signal is AC coupled (C44) through a smoothing circuit 423 (R45/C45/R46/C46/R47/R48), which converts the square wave input signal into a 15.734 KHz sine wave pilot signal 127. The pilot signal 127 is AC coupled (C47) to the Summing & Output Amplifiers 115 shown in FIG. 1.

The “Q” square wave 421 is DC coupled to the Reference Input of the PLL 411 (U4), which compares the phase of this reference input to that of the signal input to provide steering information to the phase detector that results in an error voltage being created. This error voltage is filtered and fed back into the PLL 411 (U4) to provide frequency lock to the 15.734 KHz composite video sync signal 121, which in turn locks the encoder to the video source. Capacitors (C56/C30) of monostable multivibrator 407 and PLL circuit 411, respectively, decouple the power supply.

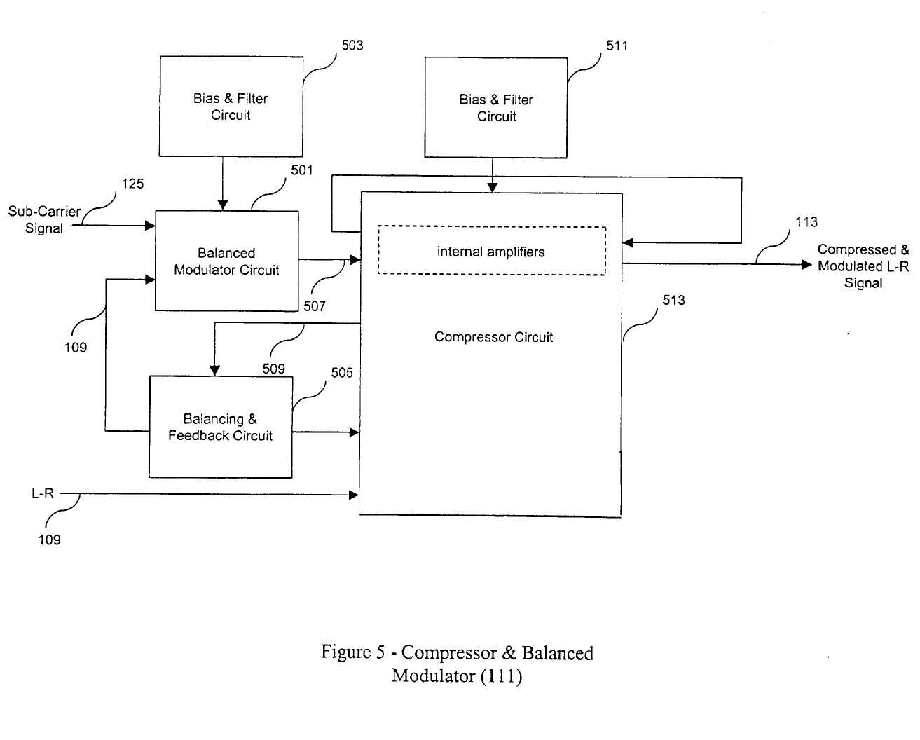

As shown in FIG. 1, the sub-carrier signal 125 and the L−R audio sub-channel 109 are fed to the Compressor & Balanced Modulator 111. Referring to FIG. 5, a compressor circuit 513 receives and increases the signal-to-noise ratio of the L−R audio sub-channel 109 by applying the BTSC standard 2:1 compression ratio. The compressed L−R audio sub-channel signal 509 is fed to a balanced modulator circuit 501 via a balancing and feedback circuit 505. The balanced modulator circuit 501, in conjunction with amplifiers internal to the compressor circuit 513, produces a double-sideband suppressed carrier amplitude modulated (AM-DSB/SC) L−R audio signal 113, centered around the 31.468 KHz carrier. The frequency range of the AM-DSB/SC L−R audio signal 113 is 17.468 KHz (31.468 KHz−14.000 KHz) to 45.468 KHz (31.468 KHz+14.000 KHz). Bias & filter circuits 503 and 511 apply power to the balanced modulator 501 and compressor 513 circuits, respectively.

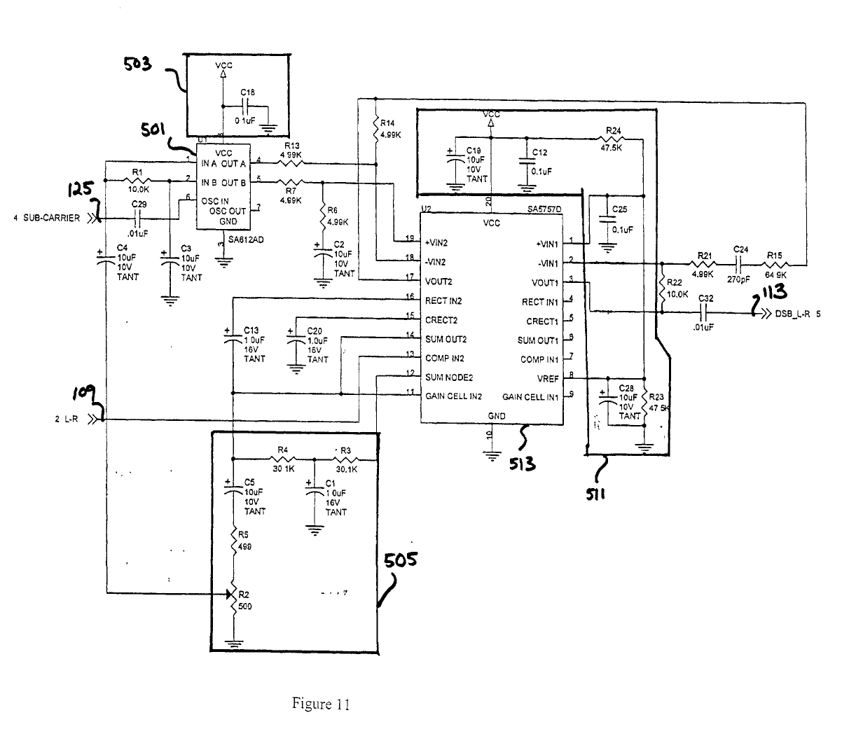

Referring to FIG. 11, the compressor circuit 513 is implemented with a dedicated Philips Compandor (compressor/expander) IC (U2) specifically designed to produce the required 2:1 compression ratio. The compressor (U2) contains two undedicated operational amplifiers that are used in the balanced modulator circuit 501. The compressor (U2) is designed to have a 0 dB amplitude reference level of 0.100 Vᵣₘₛ so that input amplitudes below 0.100 Vᵣₘₛ are multiplied by a factor of 2 and amplitudes above 0.100 Vᵣₘₛ are multiplied by a factor of 0.5.

A capacitor (C20) sets the attack and release time constant of the compressor (U2) to about 40 ms. The +5.0 Volts DC power supply (+V_{cc}) is filtered (C19/C12) and applied to the compressor (U2). The compressor (U2) also contains a DC Reference and an internal amplifier that is biased and filtered (R24/C25/R23/C28) to ½ of +V_{cc}.

The L−R audio sub-channel signal 109 is applied to the compressor (U2 pin 13), which is the input to the internal summing amplifier. The output of the internal summing amplifier is fed to the internal rectifier via a capacitor (C13). Additionally, the internal summing amplifier is controlled by a feedback circuit (R4/C1/R3) that yields a gain of about 6. A capacitor (C1) decouples the AC components of the feedback signal so that only DC feedback is provided to the amplifier.

The output of the internal summing amplifier, the compressed L−R audio sub-channel signal 509 from FIG. 5, is AC coupled (C4) to the input of the balanced modulator 501 (U1) via a balancing circuit (C5/R5/R2). A potentiometer (R2) precisely sets the balance between the L+R main audio channel 107 from FIG. 1 and the L−R audio sub-channel 109. A resistor (R1) provides a DC balance between the Balanced Modulator 501 (U1) differential inputs, while a capacitor (C3) provides AC decoupling of the signal path to ground. The 31.468 KHz sub-carrier signal 125 is AC coupled (C29) to the balanced modulator 501 (U1).

The differential AM double-sideband signal 507 from FIG. 5 is fed to a difference amplifier internal to the compressor 513 (U2); one signal is fed (via R13) to the inverting input and the other signal is fed (via R7/R6/C2) to the non-inverting input. A resistor (R14) provides feedback with a gain of 1. The difference amplifier is DC biased by virtue of the fact that DC coupling is utilized. The output of the difference amplifier is fed (via R15/C24/R21) to the inverting input of a second amplifier internal to the compressor 513 (U2). A high pass filter (R15/C24) serves to attenuate any low frequency signals (less than 15.0 KHz) that might remain after processing. A feedback resistor (R22) provides a gain of about 2. The AM-DSB/SC L−R audio signal 113 is AC coupled (C32) to the Summing & Output Amplifiers 115 shown in FIG. 1.

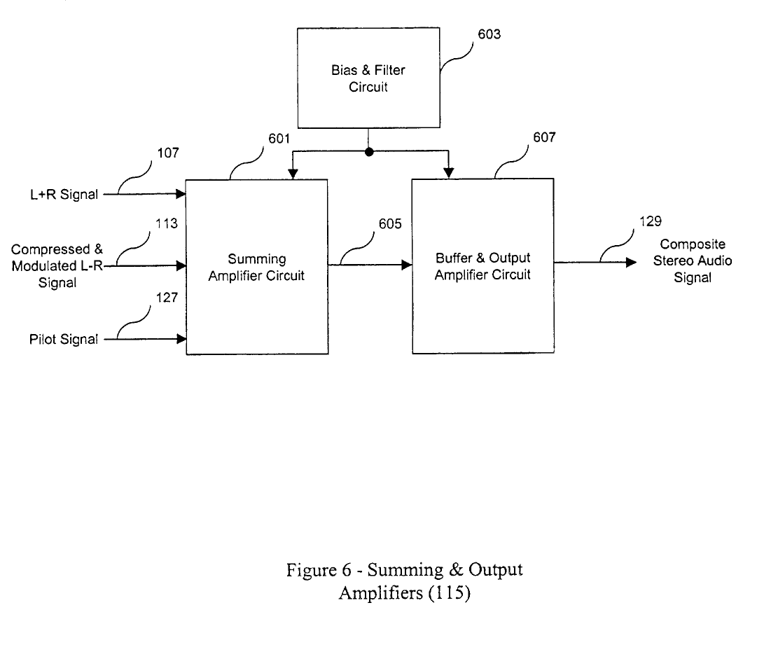

As shown in FIG. 1, the Summing & Output Amplifier circuit 115 generates the composite stereo audio signal 129. As shown in FIG. 6, a summing amplifier circuit 601 sums the L+R main audio channel 107, the compressed and modulated L−R audio sub-channel 113, and the pilot signal 127. The summed audio signal 605 is passed through a buffer & output amplifier circuit 607, which provides the final composite stereo audio output level that will be passed to the RF Modulator and Output Amplifier 131 shown in FIG. 1 to assure that the proper modulation level is achieved. The buffer & output amplifier circuit 607 also provides isolation and buffering between the previous components of system 100 and the input of the RF Modulator & Output Amplifier 131. A bias & filter circuit 603 applies power to the summing amplifier circuit 601 and to the buffer & output amplifiers circuit 607.

Referring to FIG. 12, the L+R main audio channel signal 107, the compressed and modulated L−R audio sub-channel signal 113, and the pilot signal 127 are fed to the inverting input of the summing amplifier (U5B) of the summing amplifier circuit 601 via three resistors (R36, R41, and R44). A feedback resistor (R49) of amplifier circuit 601 provides a gain of about 12. A capacitor (C51) decouples the +5.0 Volts DC power supply (+V_{cc}), while a circuit (R37/R42/C38) of bias and filter circuit 603 biases the amplifier (U5B) to ½ of +V_{cc}.

The summed audio signal 605 shown in FIG. 6, is AC coupled (C53) to the buffer & output amplifier circuit 607 and fed (via R56) to inverting input of an amplifier (U5A) of buffer & output amplified circuit 607. A capacitor (C35) decouples the +5.0 Volts DC power supply (+V_{cc}) and resistors (R37/R42) bias the amplifier (U5A) to ½ of +V_{cc}. A feedback resistor (R51) provides a gain of about 5. The output of the amplifier (U5A) is the composite stereo audio signal 129, which is AC coupled (C55) to the RF Modulator & Output Amplifier 131 shown in FIG. 1.

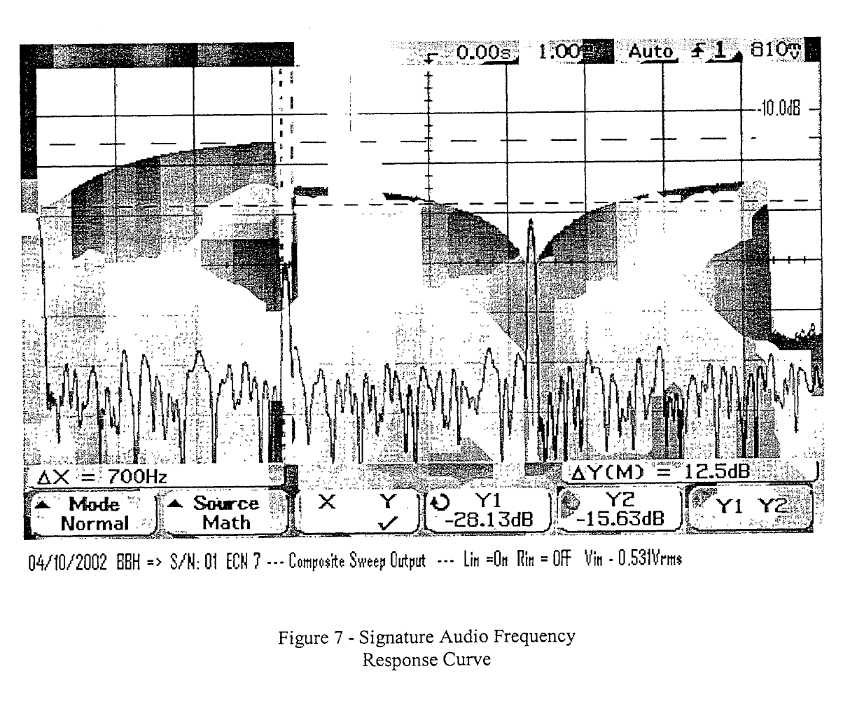

FIG. 7 is a plot of the signature audio frequency response of system 100 as described herein. Through unique treatment and implementation of the pre-emphasis characteristics of the L−R audio sub-channel noise reduction circuit, system 100 generates a composite audio signal with a unique audio frequency response that occupies the entire 15 KHz audio range.

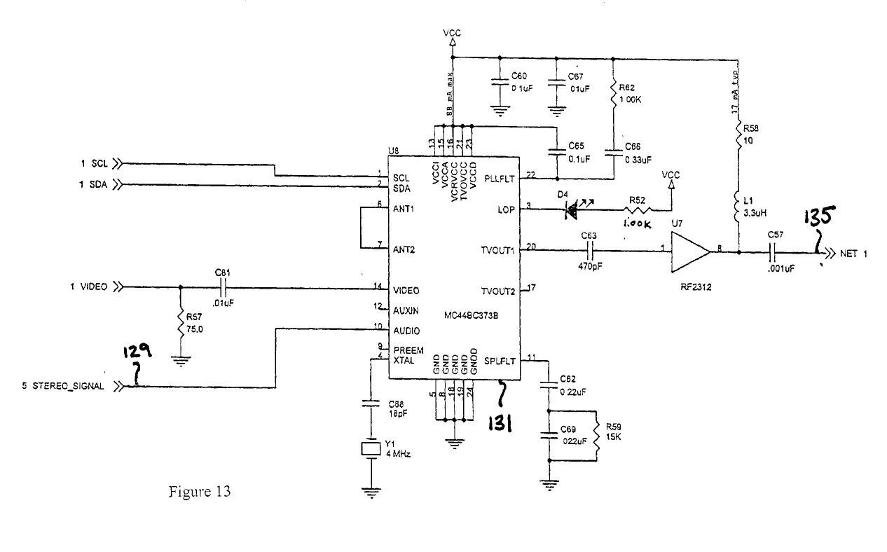

As shown in FIG. 1, the composite stereo audio signal 129 can be coupled to an RF Modulator and Output Amplifier circuit 131. Referring to FIG. 13, in an embodiment of the present invention, the composite stereo audio signal 129 of FIG. 1 is coupled to a specifically designed Motorola RF modulator chip (U8), which combines the video and audio input sources and modulates them onto an NTSC compliant VHF/UHF carrier.

The RF modulator chip (U8) user interface and internal functions are controlled by an external microcontroller or microprocessor 133 of FIG. 1 via the I²C bus. Video input is AC coupled (C61) to the RF modulator chip (U8) from the YELLOW female RCA jack on J1 via a terminator resistor (R57). The composite stereo audio signal 129 is input to RF modulator chip (U8) via Pin #10. The oscillator is set to a frequency of 4.000 MHz (via Y1/C68) and the RF PLL loop filter is controlled by C65/C66/R62. The audio section PLL loop filter is determined by C62/C69/R59. Loop lock is visually indicated by D4/R52. Capacitors (C60/C67) decouple the power supply. The RF output is AC coupled (C63) to an RF amplifier (U7) that is biased via R58/L1. The RF amplifier (U7) output is AC coupled (C57) to P1 (Pin #20) in FIG. 9.

The embodiment described herein is merely exemplary in that the invention contemplates all known variations of discrete component values and known combinations of discrete components for performing the described signal control functions. These variations and combinations are known to those skilled in the art and are within the scope of the invention as set forth herein.

What is claimed is:

1. A system for generating a composite audio signal capable of modulating a radio frequency carrier to a standard television channel for cable transmission, comprising:
an input for a first audio signal;
an input for a second audio signal;
an input for a video signal;
a first generating circuit for generating a third audio signal, whereby the third audio signal is the sum of first and second audio signals input into the system;
a second generating circuit for generating a fourth audio signal, whereby the fourth audio signal is the difference between first and second audio signals input into the system;
a first pre-emphasizing circuit for pre-emphasizing the fourth audio signal a first time;
a second pre-emphasizing circuit for pre-emphasizing the fourth audio signal a second time;
an extracting circuit for extracting a timing signal of a first frequency from the video signal;
a pilot signal circuit for generating, from the timing signal, a pilot signal of the first frequency and a sub-carrier signal of a second frequency;
a compressing circuit for compressing the twice pre-emphasized fourth audio signal;
a suppressing circuit for suppressing the sub-carrier signal and for modulating the compressed fourth audio signal; and
a composite signal circuit for generating the composite audio signal from the third audio signal, the compressed and modulated fourth audio signal, and the pilot signal.

2. The system according to claim 1, further comprising one or more circuits for attenuating the first and second audio signals.

3. The system according to claim 1, wherein the circuit for generating a third audio signal comprises a summing amplifier circuit.

4. The system according to claim 1, further comprising a circuit for pre-emphasizing the third audio signal.

5. The system according to claim 1, wherein the circuit for generating a fourth audio signal comprises a difference amplifier circuit.

6. The system according to claim 1, wherein the circuit for pre-emphasizing the fourth audio signal a first time is an RC circuit with a time constant of about 65 to 85 microseconds.

7. The system according to claim 1, wherein the circuit for pre-emphasizing the fourth audio signal a second time is an RC circuit with a time constant of about 200 to 400 microseconds.

8. The system according to claim 1, wherein the fourth audio signal is amplitude modulated-double sideband/suppressed carrier.

9. The system according to claim 1, wherein the third audio signal is frequency modulated.

10. The system according to claim 1, wherein the second frequency is two times the first frequency.

11. The system according to claim 1, wherein the circuit for generating the pilot signal and the sub-carrier signal comprises:
a peak clipping limiter;
an inverter;
a monostable multivibrator;
a phase-locked loop circuit;
a divide-by-two counter; and
one or more waveform smoothing circuits.

12. The system according to claim 1, wherein the circuit for compressing the dual pre-emphasized fourth audio signal comprises a dedicated integrated circuit compressor.

13. The dedicated integrated circuit compressor according to claim 12, wherein the compression ratio is about 2:1.

14. The dedicated integrated circuit compressor according to claim 12, wherein the compressor comprises at least two undedicated operational amplifiers.

15. The system according to claim 1, wherein the circuit for suppressing the sub-carrier signal and for modulating the compressed fourth audio signal comprises a dedicated integrated circuit balanced modulator.

16. The system according to claim 15, wherein the circuit for suppressing the sub-carrier signal and for modulating the compressed fourth audio signal further comprises a circuit for automatically adjusting the balanced modulator.

17. The system according to claim 1, wherein the sub-carrier signal is suppressed to greater than about 55 dB.

18. The system according to claim 1, wherein the circuit for generating the composite audio signal comprises:
a summing amplifier circuit;
a buffer circuit; and
an output amplifier circuit.

19. A method of generating a composite audio signal capable of modulating a radio frequency transmitter to a standard television channel for cable transmission, comprising the steps of:
receiving a first audio signal, a second audio signal, and a video signal;
summing the first and second audio signals, whereby a third audio signal is generated;
taking the difference between the first and second audio signals, whereby a fourth audio signal is generated;
pre-emphasizing the fourth audio signal a first time;
pre-emphasizing the fourth audio signal a second time;
extracting a timing signal of a first frequency from the video signal;
generating, from the timing signal, a pilot signal of the first frequency and a sub-carrier signal of a second frequency;
compressing the twice pre-emphasized fourth audio signal;
suppressing the sub-carrier signal and modulating the compressed fourth audio signal; and
summing the third audio signal, the compressed and modulated fourth audio signal, and the pilot signal, whereby the composite audio signal is generated.

20. The method according to claim 19, further comprising the step of attenuating the first and second audio signals.

21. The method according to claim 19, further comprising the step of pre-emphasizing the third audio signal.

22. The method according to claim 19, wherein the step of generating a pilot signal and a sub-carrier signal further comprises the steps of:
doubling the first frequency of the timing signal to generate a square wave signal of the second frequency;
smoothing the square wave signal of the second frequency to generate a sub-carrier signal of the second frequency;
dividing the first frequency of the square wave signal by two to generate a square wave signal of the first frequency; and
smoothing the square wave signal of the first frequency to generate a pilot signal of the first frequency.

23. The method according to claim 19, further comprising the steps of:
buffering the composite audio signal; and
amplifying the composite audio signal;

24. A method of generating a composite audio signal capable of modulating a radio frequency transmitter to a standard television channel for cable transmission, comprising:
means for receiving a first audio signal, a second audio signal, and a video signal;
means for summing the first and second audio signals, whereby a third audio signal is generated;
means for taking the difference between the first and second audio signals, whereby a fourth audio signal is generated;
means for pre-emphasizing the fourth audio signal a first time;
means for pre-emphasizing the fourth audio signal a second time;
means for extracting a timing signal of a first frequency from the video signal;
means for generating from the timing signal a pilot signal of the first frequency and a sub-carrier signal of a second frequency;
means for compressing the dual pre-emphasized fourth audio signal;
means for suppressing the sub-carrier signal and modulating the compressed fourth audio signal; and
means for summing the third audio signal, the compressed and modulated fourth audio signal, and the pilot signal, whereby the composite audio signal is generated.

25. The method according to claim 24, further comprising means for attenuating the first and second audio signals.

26. The method according to claim 24, wherein the means for summing the first and second audio signals comprises a summing amplifier circuit.

27. The method according to claim 24, whereby the third audio signal is frequency modulated.

28. The method according to claim 24, further comprising means for pre-emphasizing the third audio signal.

29. The method according to claim 24, wherein the means for taking the difference between the first and second audio signals comprises a difference amplifier circuit.

30. The method according to claim 24, wherein the means for pre-emphasizing the fourth audio signal a first time is an RC circuit with a time constant of about 65 to 85 microseconds.

31. The method according to claim 24, wherein the means for pre-emphasizing the fourth audio signal a second time is an RC circuit with a time constant of about 200 to 400 microseconds.

32. The method according to claim 24, wherein the means for generating a pilot signal and a sub-carrier signal further comprises:
means for doubling the first frequency of the timing signal, whereby a square wave signal of the second frequency is generated;
means for smoothing the square wave signal of the second frequency, whereby the sub-carrier signal of the second frequency is generated;
means for dividing the second frequency of the square wave signal by two, whereby a square wave signal of the first frequency is generated; and
means for smoothing the square wave signal of the first frequency, whereby the pilot signal of the first frequency is generated.

33. The method according to claim 32, wherein the means for doubling the first frequency of the timing signal comprises a phase-locked loop circuit.

34. The method according to claim 24, wherein the means for compressing the dual pre-emphasized fourth audio signal comprises a dedicated integrated circuit compressor.

35. The method according to claim 24, whereby the fourth audio signal is amplitude modulated-double sideband/suppressed carrier, centered around the sub-carrier frequency.

36. The method according to claim 24, wherein the means for suppressing the sub-carrier signal and for modulating the compressed fourth audio signal comprises a dedicated integrated circuit balanced modulator.

37. The means for suppressing the sub-carrier signal and for modulating the compressed fourth audio signal according to claim 36, further comprising means for automatically adjusting the balanced modulator.

38. The method according to claim 24, further comprising:
means for buffering the composite audio signal; and
means for amplifying the composite audio signal.
